(19) United States
(12) Patent Application Publication
(10) Pub. No.: US 2022/0049736 A1
(43) Pub. Date: Feb. 17, 2022

(54) SECURING ELEMENT

(71) Applicant: Hilti Aktiengesellschaft, Schaan (LI)

(72) Inventors: Eric SCHULTE SUEDHOFF, Feldkirch (AT); Stefan HAAG, Buchs (CH); Simon BEAUVAIS, Shanghai (CN); Furkan GUELTEKIN, Buchs SG (CH)

(21) Appl. No.: 17/416,723

(22) PCT Filed: Dec. 3, 2019
(86) PCT No.: PCT/EP2019/083476

§ 371 Date: Jun. 21, 2021

(30) Foreign Application Priority Data
Dec. 20, 2018 (EP) 18214539.1

(51) Int. Cl. F16B 19/14

(52) U.S. Cl. CPC F16B 19/14

(57) ABSTRACT

A fastening element is provided, comprising a shank, which defines a driving-in direction, the shank having a front end, facing in the driving-in direction, and a rear end, facing counter to the driving-in direction, the shank having a periphery having a profile ridge that is inclined in relation to the driving-in direction at an acute angle. According to one aspect, the profile ridge has a front flank, facing in the fastening direction, and a rear flank, facing counter to the fastening direction, the front flank having a greater area content than the rear flank. According to a further aspect, the fastening element has a tip region, which has a convex portion.

### BACKGROUND OF THE INVENTION

The present invention relates to a fastening element, such as for example a stud, nail or pin.

### PRIOR ART

Fastening elements of this type, such as for example steel nails, studs and the like, are used in fastening technology for fastening items on hard receiving materials, such as concrete, metal or rock. For this purpose, the fastening elements have a shank, in particular with a tip tapering in the setting direction and, lying at the other end of the shank, a head which is enlarged in comparison with the diameter of the shank. The driving-in operation is performed at high speed, by impact or by the element being driven in for example by means of combustion-powered setting devices.

There are known fastening elements in which the shank has at its periphery a profile with multiple profile ridges and grooves lying in between. Designs in which the profile ridges are inclined in relation to the fastening direction are also known.

### SUMMARY OF THE INVENTION

One object is to provide a fastening element that has a great fastening force.

A fastening element comprises a shank, which defines a driving-in direction, the shank having a front end, facing in the driving-in direction, and a rear end, facing counter to the driving-in direction, the shank having at its periphery a profile ridge that is preferably inclined in relation to the driving-in direction at an acute angle, and the shank having a cross-sectional area, oriented perpendicularly to the driving-in direction, with an area content a shank diameter measured in the region of the profile ridge.

According to a first aspect, the profile ridge has a front flank, facing in the fastening direction, and a rear flank, facing counter to the fastening direction, the front flank having a greater area content than the rear flank. As a result, that area of the profile ridge that is heated up by friction during a driving-in operation, and as a result contributes to a greater extent to a force holding the fastening element in the base material, is increased at the expense of areas with a smaller contribution to the holding force, and so altogether the fastening force of the fastening element is increased.

According to a further aspect, the fastening element comprises a tip region adjoining the front end of the shank and having a nail tip, the tip region having a tip length, measured in the driving-in direction, and a cross-sectional area, oriented perpendicularly to the driving-in direction, with an area content that is as great at a transition from the tip region to the shank as the area content of the cross-sectional area of the shank and decreases from the shank to the nail tip, and the tip region comprising a convex portion. Preferably, the tip region consists of the convex portion. On account of the convex form of the tip region, starting from the nail tip, the area content of the cross-sectional area of the tip region quickly increases, and so considerable frictional heat is generated at the beginning of a driving-in operation. This allows a surface of the profile ridge to contribute to a greater extent to a force holding the fastening element in the base material, and so the fastening force of the fastening element is increased.

An advantageous embodiment is characterized in that the tip region has a tip region midpoint, which is the same distance, measured in the driving-in direction, away from the transition from the tip region to the shank and from the nail tip, and the area content of the cross-sectional area of the tip region at the midpoint of the nail being more than 25% of the area content of the cross-sectional area of the shank. Preferably, the area content of the cross-sectional area of the tip region at the midpoint of the nail is more than 50%, particularly preferably more than 70% or more than 75%, of the area content of the cross-sectional area of the shank.

An advantageous embodiment is characterized in that the shank has a shank diameter, measured in the region of the profile ridge, and the tip length being 1.1 to 1.6 times the shank diameter.

An advantageous embodiment is characterized in that an angle of inclination of the profile ridge with respect to the driving-in direction is less than 20°. It is thereby ensured that an impact on the fastening element in the driving-in direction causes a rotation of the fastening element. Under some circumstances, the profile ridge is not suitable as a thread that would convert a rotation of the fastening element into a forward drive.

An advantageous embodiment is characterized in that a cross-sectional area of the shank has an area content that does not change significantly along the driving-in direction.

An advantageous embodiment is characterized in that the fastening element comprises a head adjoining the rear end of the shank.

An advantageous embodiment is characterized in that the shank has two or at least three, preferably at least four, profile ridges. Particularly preferably, the profile ridges are distributed uniformly at the periphery of the shank.

An advantageous embodiment is characterized in that the tip region has a cross-sectional area of which the area content steadily decreases from the shank to the nail tip. Preferably, the profile ridge continues from the shank into the tip region. Particularly preferably, the profile ridge continues substantially up to the nail tip.

### EXEMPLARY EMBODIMENT

Further advantages and measures of the invention are provided by the subclaims, the following description and the drawings. The invention is represented in an exemplary embodiment in the drawings,

in which:

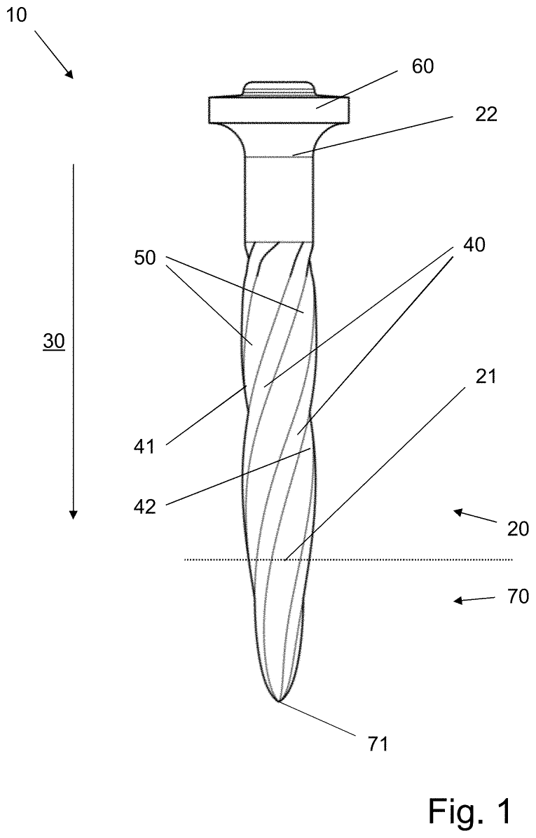

FIG. 1 shows a fastening element according to the invention in a side view,

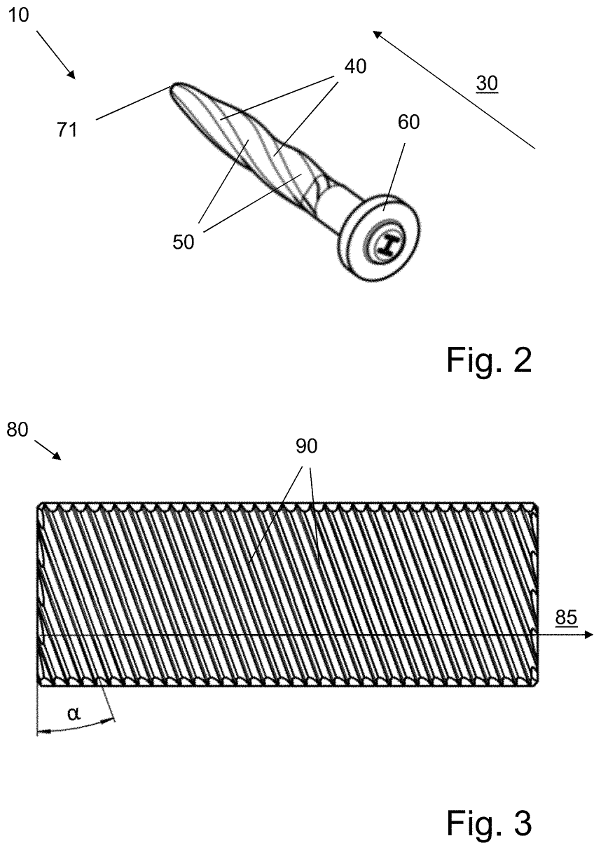

FIG. 2 shows the fastening element in an oblique view,

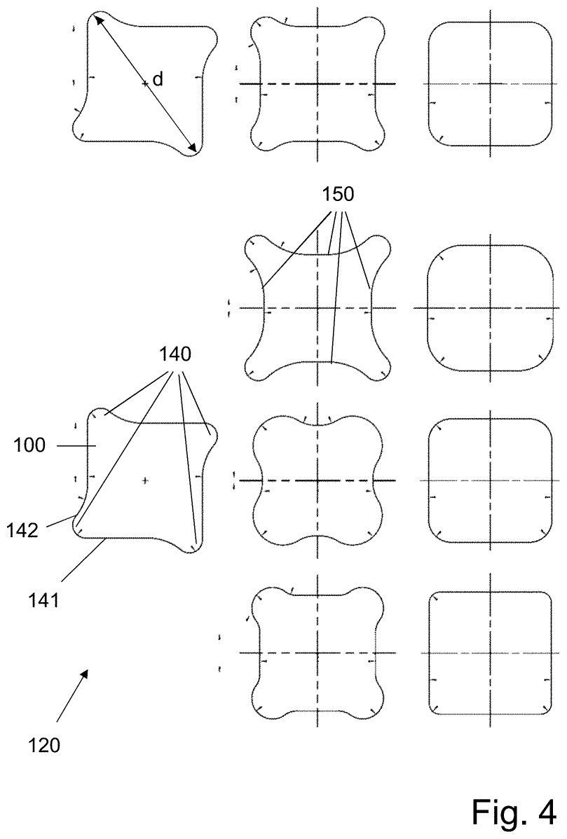

FIG. 3 shows a rolling die for producing the fastening element,

FIG. 4 shows various exemplary embodiments of a cross-sectional area of a fastening element and

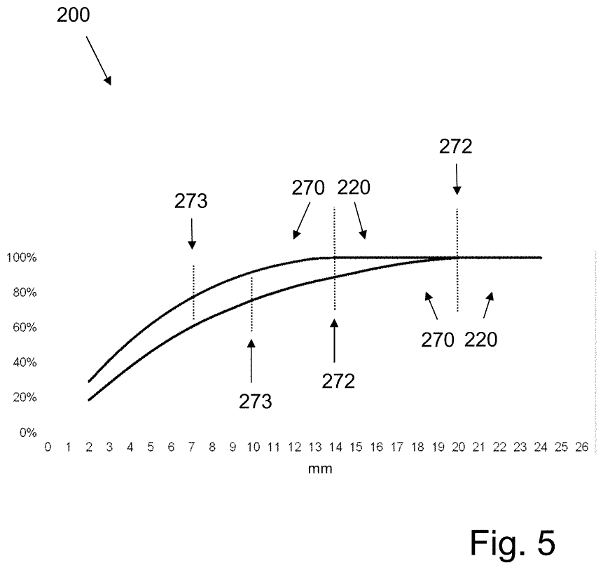

FIG. 5 shows a variation of an area content of a cross-sectional area of a fastening element.

FIGS. 1 and 2 show a fastening element 10 in a side view. The fastening element 10 comprises a shank 20, which defines a driving-in direction 30, and a front end 21, facing in the driving-in direction 30, and also a rear end 22, facing counter to the driving-in direction 30. The shank 20 has a cross-sectional area oriented perpendicularly to the driving-in direction 30 and at its periphery a number of profile ridges 40 inclined in relation to the driving-in direction at an acute angle of 15°. Respectively formed between two profile ridges 40 are intermediate profile regions 50, which in the present example are formed as grooves. The rear end 22 of the shank 20 is adjoined by a head 60. The front end 21 of the shank 20 is adjoined by a convex tip region 70 with a preferably pointed nail tip 71. The profile ridges 40 have in each case a front flank 41, facing in the fastening direction 30, and a rear flank 42, facing counter to the fastening direction 30, and continue from the shank 20 into the tip region 70 up to the nail tip 71.

FIG. 3 shows a rolling die 80, which can be used for producing the fastening element, in that a blank with a shank that is not shown is rolled between the rolling die 80 and a similarly shaped mating die in a rolling direction 85. The rolling die 80 has a multiplicity of channels 90, and so during the rolling a profile with profile ridges is rolled into a periphery of the shank. The channels 90 are inclined with respect to a longitudinal direction of the shank which is oriented perpendicularly to the rolling direction 85, by an acute angle of inclination a, and so the rolled profile ridges are also inclined with respect to the longitudinal direction of the shank by the angle α.

For producing a tip region with a nail tip adjoining the front end of the shank, the rolling die 80 and the mating die have regions that lie opposite one another during the rolling. A gap thereby occurring between the regions mentioned tapers in a direction running away from the channels 90, and so a material of the tip region is pinched between the rolling die 80 and the mating die. As a result, the tip region is on the one hand shaped and on the other hand heated, so that excess material can easily be thermally removed from the tip region. When in the case of some exemplary embodiments the profile ridges of the fastening element are intended to extend up to the nail tip, a thermal process involving drawing two nail blanks apart according to EP 1 057 553 B1 is preferably used. In the case of an exemplary embodiment that is not shown, the channels in the rolling die and/or the mating die extend into the aforementioned tapering gap.

FIG. 4 shows a cross-sectional area 100, oriented perpendicularly to the driving-in direction, of a shank 120 of a fastening element respectively according to a number of different exemplary embodiments. The respective shank 120 has in each case four profile ridges 140 distributed uniformly at the periphery of the respective shank 120 and, lying in between, intermediate profile regions 150, which in the case of the exemplary embodiments represented on the left and in the middle in FIG. 4 are formed as grooves. In the case of the exemplary embodiments represented on the right in FIG. 4, the intermediate profile regions 150 are formed as planar; in the case of exemplary embodiments that are not represented, the intermediate profile regions are formed as concave. The profile ridges are distinguished by the fact that they project radially with respect to a circular cross-sectional form and with respect to the intermediate profile regions. The respective shank 120 has a shank diameter d, measured in the region of the profile ridges.

On account of the inclination of the profile ridges 140 with respect to the driving-in direction, each profile ridge 140 has a front flank 141, facing in the fastening direction, and a rear flank 142, facing counter to the fastening direction, the front flank 141 being heated up by friction to a greater extent than the rear flank 142 during a driving-in operation. The front flank 141 has in this case a greater area content than the rear flank 142, and so altogether a fastening force of the fastening element is increased.

FIG. 5 shows in a diagram 200 a variation of an area content of a cross-sectional area of a fastening element in two exemplary embodiments, plotted as a percentage of an area content in the region of a shank 220 of the fastening element against a distance from a nail tip in millimeters. In the region of the shank of the fastening element, the area content does not change significantly along the driving-in direction (100%). In a tip region 270, the area content steadily decreases, starting from 100% at a transition 272 from the tip region 270 to the shank 220, to a needle tip (0 mm, 0%). The tip region 270 has a tip region midpoint 273, which is the same distance away from the transition 272 and from the nail tip. At the tip region midpoint 273, the area content of the cross-sectional area of the tip region 270 is in the first exemplary embodiment (lower curve) 72%, in the second exemplary embodiment (upper curve) 78% of the area content of the cross-sectional area of the shank 220. Furthermore, a tip length of the tip region from the transition 272 to the nail tip is in the first exemplary embodiment (lower curve) 1.5 times, in the second exemplary embodiment (upper curve) 1.2 times the shank diameter.

The invention has been explained above on the basis of a number of exemplary embodiments of a fastening element. The features described can be transferred individually or in combination from each exemplary embodiment to all other exemplary embodiments as long as they do not contradict one another. It is pointed out that the fastening element according to the invention can also be used for other purposes.

1. A fastening element, comprising a shank, which defines a driving-in direction, the shank having a front end, facing in the driving-in direction, a rear end, facing counter to the driving-in direction, and, a periphery having a profile ridge, also comprising a tip region adjoining the front end of the shank having a nail tip, the shank having a cross-sectional area, oriented perpendicularly to the driving-in direction, with an area content, the tip region having a tip length, measured in the driving-in direction, and a cross-sectional area, oriented perpendicularly to the driving-in direction, with an area content that is as great at a transition from the tip region to the shank as the area content of the cross-sectional area of the shank and decreases from the shank to the nail tip, and the tip region comprising a convex portion.

2. The fastening element as claimed in claim 1, the tip region having a tip region midpoint, which is the same distance, measured in the driving-in direction, away from the transition from the tip region to the shank and from the nail tip, and the area content of the cross-sectional area of the tip region at the midpoint of the nail being more than 25% of the area content of the cross-sectional area of the shank.

3. The fastening element as claimed in claim 2, the area content of the cross-sectional area of the tip region at the midpoint of the nail being more than 50% of the area content of the cross-sectional area of the shank.

4. The fastening element as claimed in claim 3, the area content of the cross-sectional area of the tip region at the midpoint of the nail being more than 70% of the area content of the cross-sectional area of the shank.

5. The fastening element as claimed in claim 1, the shank having a shank diameter, measured in the region of the profile ridge, and the tip length being 1.1 to 1.6 times the shank diameter.

6. The fastening element as claimed in claim 1, the area content of the cross-sectional area of the shank not changing significantly in the driving-in direction.

7. The fastening element as claimed in claim 1, the area content of the cross-sectional area of the tip region decreasing steadily from the shank to the nail tip.

8. The fastening element as claimed in claim 1, the profile ridge continuing from the shank into the tip region.

9. The fastening element as claimed in claim 8, the profile ridge continuing substantially up to the nail tip.

10. The fastening element as claimed in claim 1, the profile ridge being inclined in relation to the driving-in direction at an acute angle.

11. The fastening element as claimed in claim 10, an angle of inclination of the profile ridge with respect to the driving-in direction being less than 20°.

12. The fastening element as claimed in claim 10, the profile ridge having a front flank, facing in the fastening direction, and a rear flank, facing counter to the fastening direction, the front flank having a greater area content than the rear flank.

13. The fastening element as claimed in claim 1, the shank having two profile ridges.

14. The fastening element as claimed in claim 13, the profile ridges being distributed uniformly at the periphery of the shank.

15. The fastening element as claimed in claim 1, the tip region consisting of the convex portion.

16. The fastening element as claimed in claim 4, the area content of the cross-sectional area of the tip region at the midpoint of the nail being more than 75% of the area content of the cross-sectional area of the shank.

17. The fastening element as claimed in claim 11, the profile ridge having a front flank, facing in the fastening direction, and a rear flank, facing counter to the fastening direction, the front flank having a greater area content than the rear flank.

18. The fastening element as claimed in claim 13, having at least three profile ridges.

19. The fastening element as claimed in claim 13, having at least four profile ridges.

20. The fastening element as claimed in claim 2, the shank having a shank diameter, measured in the region of the profile ridge, and the tip length being 1.1 to 1.6 times the shank diameter.
